(19) United States
(12) Patent Application Publication
(10) Pub. No.: US 2003/0133207 A1
(43) Pub. Date: Jul. 17, 2003

(54) Optical filter

(76) Inventors: Kazuhiko Minami, Yamagata (JP); Tokutaro Hara, Yokohama (JP); Daisuke Suzuki, Yokohama (JP)

Correspondence Address: 3M INNOVATIVE PROPERTIES COMPANY, PO BOX 33427, ST. PAUL, MN, 55133-3427, US

(21) Appl. No.: 10/210,539

(22) Filed: Jul. 31, 2002

(30) Foreign Application Priority Data
Aug. 3, 2001 (JP) 2001-236518

(51) Int. Cl. G02B 5/22

(52) U.S. Cl. 359/885

(57) ABSTRACT

An optical filter (1) includes: a film layer (3) formed of an optical film having a front surface (301) observed by an observer and a back surface opposing to the front surface (301), a releasable adhesive layer which is firmly placed on the back surface of the film layer and can be releasably adhered to the adhesion surface (40). The optical filter (1) further provides a flexible tab (10a, 10b) coupled integrally with the film layer (3).

This application claims priority from Japan Application No. 2001-236518 filed Aug. 3, 2001.

### FIELD OF THE INVENTION

This invention relates to an optical filter comprising an optical film such as louver film and antireflection film, and an adhesive layer fixing the film layer releasably on a surface, and further including a tab for facilitating the release operation.

The optical filter of this invention is releasably fixed on a surface including a screen of a display device such as a liquid crystal display. For example, if the above described film layer comprises a louver layer, the film can serve as a so-called privacy filter or anti-peeping filter, which will prevent anyone other than the display user (operator) from viewing the display screen.

### BACKGROUND OF THE INVENTION

A liquid crystal display (also referred to as liquid crystal display device or LCD) usually comprises a liquid crystal display panel (hereafter sometimes referred to as “liquid crystal panel”) and a light source (that is, a back light) for illuminating from the back side of liquid crystal panel (the side opposite to the display surface).

When using a liquid crystal display, an optical filter comprising various kinds of optical films as film layers may be placed on the display screen. Such an optical film can provide optical functions and protect the screen from being damaged. The optical film may include an antireflection film (optical film having an antireflection coating) and a louver film (optical film having a louver layer).

For example, in the case of usual backlighting, light rays are emitted through the liquid crystal panel not only directly toward the user of the display but also at angles away from the user such that others may be able to view the display information thus making it difficult to preserve the privacy of that information. Furthermore, if a liquid crystal display is on-vehicle equipment such as a car navigation system, displayed images are sometimes reflected on the front window, blocking the driver's sight. In such a case, a louver film having a number of small louvers (also referred to as louver-like element) inside is incorporated in the optical filter attached to the display screen, and in order to preserve privacy and effectively prevent the reflection of displayed image on the front window. This is achieved by preventing unnecessary radiation of the beam transmitting through the liquid crystal panel in the lateral direction of display screen. A number of louvers incorporated in the louver film have the effect of controlling the radiation direction of the beam transmitting it within a given range of radiation angle (the direction control effect). Thus it can prevent effectively the unnecessary radiation of the beam transmitting through the liquid crystal panel in the lateral direction of display screen. Such a louver film is also called Light Control Film.

The configuration method for producing and use of the louver films are disclosed in several preceding documents. For example, U.S. Pat. No. RE 27,617 has disclosed a process for producing a louver film by skiving billets of alternative plastic layers having relatively low (transparent) and high (colored) optical densities respectively. When billets are skived, colored layers provide louver-like elements, which collimate light. According to that patent specification, the elements can be extended in a direction perpendicular to the surface of louver film.

Furthermore Japanese Patent Laid-Open No. 8-224811 discloses a process where a pressure-sensitive adhesive layer is placed upon at least one main surface (either the front or back surface) of the louver film to prevent it from being damaged by handling, and the adhesive surface of the adhesive layer is covered with a transparent protective plastic film. The transparent plastic film may have a peeling surface, which is peeled off to expose the adhesive surface. Then the film can be adhered to suitable body (an appliance's panel etc.) to obtain the final target product. The pressure-sensitive adhesive layer used here is formed of pressure-sensitive adhesive containing a tacky polymer. The tacky polymer is a polymer having tackiness at an ambient temperature (around at 25° C.). The tacky polymer can be produced by polymerizating a composition containing monomers, which changes into (preferably, transparent) adhesive state after the polymerization.

Furthermore “Light Control Film” made by 3M Company of St. Paul, Minn. is mentioned as an example of commercially available louver films.

Besides the louver film, there has been known a process in which a film layer formed of a transparent protective film is releasably fixed closely on a display screen. For example, Japanese Patent Laid-Open No. 2000-56694 has disclosed a protective film for screen formed of a laminate formed by laminating a rubber layer on one side of a transparent film layer having a light transmission coefficient of more than 80%, where the laminate has a light transmission coefficient of more than 80%. The above described rubber layer is formed of silicone rubber and the like. Therefore it can be adhered to and released from the display screen. Because the transparent film layer is formed of a plastic film such as polyester, it has typically a higher transparency than the above described louver film. In addition, typical plastic film does not have an antireflection function.

As described above, fixing an optical filter closely to a liquid crystal display screen gives desired optical functions. For example, if the optical filter comprises a louver layer, it effectively prevents unnecessary radiation of the beam emitted through the liquid crystal panel in the lateral direction of display screen, serving as an optical filter to protect privacy (so-called privacy filter).

Furthermore there has been tendency to prefer not permanently fixing the optical filter to the display screen, in order to remove it at any time and easily secure it again. Therefore it is preferable that the optical filter can be easily fixed on the display screen, removed from it at any time and easily secured to it again by using a releasable adhesive layer to fix the optical filter to the adhesive surface. Although this generally gives desired results, a problem has remained to be solved. It is the considerable difficulty in removing the optical filter after fixing it closely to the display screen.

For a liquid crystal display in a typical usual notebook PC (personal computer), a monitor cover with a frame is used in which liquid crystal display panel is assembled into the monitor cover so that it is enclosed by the frame of the cover, and then fixed at a predetermined site of the PC main body through the cover. For such a display with a frame, there is formed a step between the circumference of the display screen and the frame. Thus the screen is placed on a recessed part enclosed with the inner periphery of the frame in such a way that it is observable by an observer. The thickness of the optical filter is usually equal or less than the step. Further the optical filter is usually fixed on the recessed part inside the frame in such a way that it covers the entire surface of the screen as far as possible. In addition, the entire surface of the optical filter (the entire back surface) is usually attached closely to the display screen.

In such a case, there is only a small gap between the inner peripheral of the frame and the optical filter. Therefore if a user wants to remove the optical filter, it has been required to release it by inserting a nail or a pointed tool between the inner peripheral of the frame and the optical filter to apply a peeling force (force required for release) above the peeling strength of the releasable adhesive layer. That is to say, it tends to be difficult to remove the optical filter because it is difficult to apply a sufficient force with the nail and the like inserted between the ordinary-shaped optical filter and the frame.

### SUMMARY OF THE INVENTION

This invention provides an optical filter, comprising:

(a) a film layer formed of an optical film, having a front surface observed by an observer and a back surface opposing to the front surface, and

(b) a releasable adhesive layer, which is firmly placed on the back surface of the film layer and can be releasably adhered to the adhesion surface and being fixed to the adhesion surface through the releasable adhesive layer,

Where in the filter further comprises a flexible tab coupled integrally with the above described film layer.

In the optical filter of this invention, it is preferred that the above described tab comprises a tab part formed of a part of the above described film layer. Further in this invention, it is preferred that the optical filter is formed by processing a precursor of the optical filter, having a substantially rectangular surface to be observed, and that the above described tab is formed of a part of the above described precursor of the optical filter, which is left after cutting off a part including at least one of four corners of the above described precursor of the optical filter. Moreover, in this invention, it is preferred that the above described releasable adhesive layer is formed of a releasable adhesive containing a cross-linked tacky polymer or rubber-based polymer, and that the above described optical film is a louver film.

### DETAILED DESCRIPTION OF THE DRAWINGS

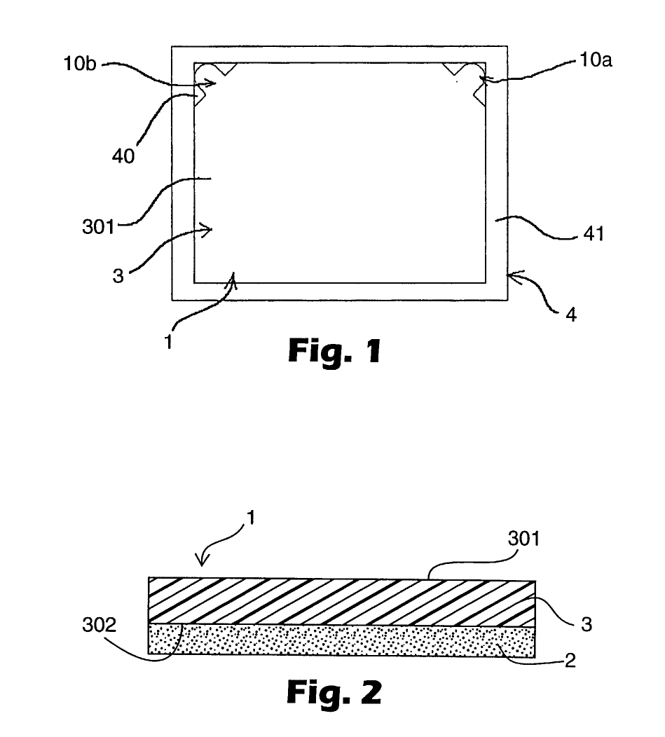

FIG. 1 is a plan view showing one embodiment in which the optical filter of this invention is adhered to the display device.

FIG. 2 is a cross section showing one embodiment of the optical filter of this invention.

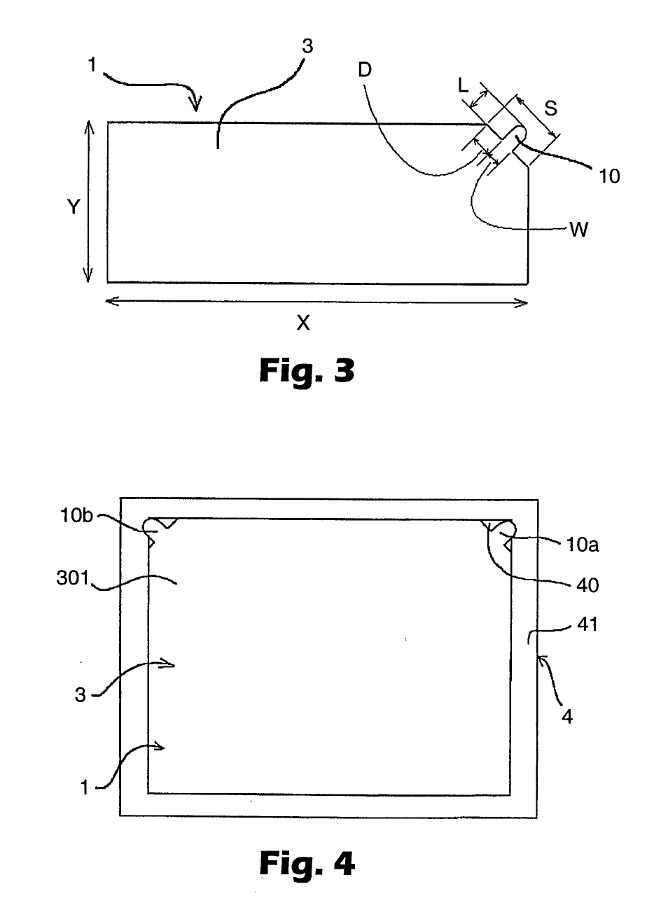

FIG. 3 is a plan view showing another embodiment of the optical filter of this invention.

FIG. 4 is a plan view showing another embodiment in which the optical filter of this invention is adhered to the display device.

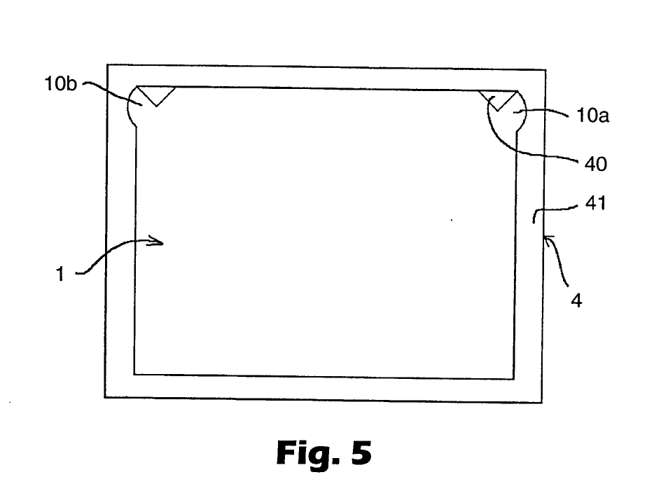

FIG. 5 is a plan view showing still another embodiment in which the optical filter of this invention is adhered to the display device.

### DETAILED DESCRIPTION OF THE INVENTION

The optical filter of this invention is characterized in that it comprises \mathring{1} a film layer including an optical film, \mathring{2} a releasable adhesive layer, which is placed on the back surface of the film layer and attaches it releasably closely to the adhesion surface (the display screen and the like), and \mathring{3} a flexible tab coupled integrally with the above described film layer.

The releasable adhesive layer allows the optical filter to be easily fixed to the adhesion surface, and makes it easy to remove the optical filter at any time. Further, because of the flexibility of the tab, it is easily bent to an angle to the adhesion surface at which the peeling force is effectively applied. That is to say, picking up and pulling up (pulling away in a direction away from the adhesion surface) the flexible tab gives an effective amount of peeling force to the optical filter, removing it easily. In addition, the releasable adhesive layer preferably has releasability such that the optical filter can be removed without damaging the adhesion surface.

Because the tab is coupled integrally with the film layer incorporated into the optical filter, the tab is effectively prevented from being removed from the optical filter if the optical filter is repeatedly attached and detached with picking up the tab. The integral tab is more excellent in such an effect than a tab formed of a separated film simply adhered to the optical filter. Furthermore the effect is easily enhanced by forming the tab from a part of the film layer.

Optical Filter

A preferred embodiment of the optical filter of this invention will be described below, with reference to FIGS. 1 and 2.

The optical filter (1) shown comprises a front surface to be observed by an observer (observed surface: 301), a film layer (3) having a front surface (301) and a back surface (302) opposing to it, and a releasable adhesive layer (2), which is firmly placed on the back surface (302) of the film layer and releasably attached closely to the adhesion surface. The releasable adhesive layer (2) is usually formed of a transparent releasable adhesive.

In the example shown, the releasable adhesive layer (2) is attached closely to the entire back surface (302) of the film layer. The optical filter (1) is fixed to the adhesion surface, that is, the surface of the display panel (the display screen: 40) of a display device (4) by the releasable adhesive layer (2). Furthermore in the example shown, the film layer (3) is formed of an optical film. A louver film and the like can be used as the optical film.

In the example, the tabs (10:10a, 10b) are formed of tab parts, which are parts of the film layer (3). Tabs (10) extend outwardly from the outer peremiter of optical filter (1). That is to say, when the optical filter is fixed on the adhesion surface, tabs (10) extend outwardly from the region of the adhesion surface (40) covered with the part of film layer (3) other than the tab parts substantially in parallel with the adhesion surface (40). Furthermore in the example shown, the direction in which a tab extends is roughly in parallel with a diagonal line of the adhesion surface (40) of a substantially rectangular shape. If the direction in which a tab extends is roughly in parallel with a diagonal line of the adhesion surface, it is easy to reduce the peeling force in picking up the tab. Thus it is preferable in that the optical filter can be easily released from the adhesion surface.

The back surface of tabs (the surface on the side of the adhesion surface) may have the releasable adhesive layer. Or the back surface of the film layer (3) other than the tab parts may have the releasable adhesive layer, and the back surface of the tabs may not. If the back surface of the tabs have the releasable adhesive layer, first the tabs may be lifted up (in a direction away from the adhesion surface) by releasing it from the adhesion surface with a nail and the like inserted between the back surface of the tabs and the adhesion surface (40), when releasing the optical filter placed on the adhesion surface. As shown, there is a part not covered with the optical filter (1) (film layer 3) around the tabs (10), and a gap through with the adhesion surface (40) is exposed. Putting a finger into the gap, the nail can be inserted easily between the back surface of the tabs and the adhesion surface. Furthermore peeling is easily done because the area when the tabs are adhered is smaller than the one covered with the part after than the tabs. Moreover if the back surface of the tabs does not have the releasable adhesive layer, the tabs may be lifted up with a nail inserted between the back surface of the tabs and the adhesion surface, too. At that time, without necessity of releasing the tabs from the adhesion surface, the optical filter is more easily removed.

In this manner the tabs are lifted, and picked by fingertips inserted between the tabs (10) and the adhesion surface (40). Further lifting up the tabs (10) from that condition gives effective peeling force to the optical filter (30).

In the example shown, the tabs are formed of the parts left after cutting two of the four corners of the optical filter's precursor, which has a substantially rectangular observed surface (the front surface) and the back surface. That is to say, the tabs are formed of the parts of the optical filter including the filter layer. In this case, the optical filter itself is preferably flexible.

In the optical filter of this invention, the number of tabs may be either more than two or less than two, as long as it is easily removed. As shown in FIG. 3, one may be possible. Preferably the number of tabs is not more than four to avoid spoiling the aesthetic appearance of the display screen when placing the optical filter.

Furthermore the dimension and the shape of the tabs should be determined so that the release operation of the optical filter is easy. For example, the tab's length in the extension direction (length of the part protruding from the film layer) is usually 2 to 15 mm, preferably 3 to 10 mm. The width of the tab in the direction orthogonal to the extension is usually more than 1.5 mm, preferably more than 2.5 mm. A tab of an elongated shape in the extension direction is effectively flexible and makes it especially easy to release the optical filter. That is to say, the tab's length in the extension is preferably larger than the width of tab. In addition, the thickness of the tab should be equal to or more than that of film layer.

A wide variety of shapes of the tabs may be adopted. For example, geometric patterns such as triangles, rectangulars, circles, sectors, ellipses and elliptic sectors, and imitative patterns (flower-, star-, hand-, foot-shape and the like) are preferred in that they show a well designed appearance to an observer. Furthermore in the example shown, the tab's tip is preferably shaped round so that the edge of the tab's tip (tip and its neighbor) is curved. In this case, the feeling to a nail or a finger becomes soft, and it is possible to apply the forth without hurting a finger and the like.

In the liquid crystal display device (4) shown in FIG. 1, the display screen (40) is enclosed with the frame (41). There is formed a step between the outer circumference of the display screen and the frame. The screen (40) is placed on the recessed part enclosed with the frame (41) in such a way that it may be observed by an observer. As shown, the optical filter (1) is fixed in such a way that it covers almost the entire screen (40) within the frame, while the tabs are usually placed on the screen (40) within the frame, too, and do not contact with the frame. As shown in FIGS. 4 and 5, however, a part of the tabs (10a, 10b) may run up onto the frame (41) unless it causes the optical filter (1) to be detached from the adhesion surface (40). In this case, it becomes easy to pick up the tabs, making it more easy to remove the optical filter.

In addition, the optical filter of this invention can be effectively applied to a display device without a step between the circumference of the display screen and the frame.

The Releasable Adhesive Layer

The releasable adhesive layer has a predetermined range of adhesive force (peeling strength) in order to release the optical filter without damaging the adhesion surface. Preferably the releasable adhesive layer is formed of a releasable adhesive containing a cross-linked tacky polymer or rubber-based polymer. Such a releasable adhesive layer allows a touch panel type of display screen and the optical filter to be closely attached together without any gaps, easily preventing malfunctions when inputting analog characters and pushing buttons on the touch panel.

The tacky polymer is a polymer showing its tackiness at ambient temperatures (about 25° C.). These tacky polymers include: acrylic polymer, nitrile-butadiene copolymer (NBR etc.), styrene-butadiene copolymer (SBR etc.), amorphous polyurethane, silicone polymer and the like. The tacky polymer is formed of one or more of them. The tacky polymer can be produced by polymerization of a mixture of monomers including a predetermined starting monomer. Usual polymerization processes such as solution polymerization, block polymerization and emulsion polymerization are used for this purpose.

As the rubber-based polymer used for the releasable adhesive layer, for example, a mixture can be used including one or more polymers selected from the group consisting of: silicone rubber, fluorine-containing rubber, acrylic rubber, ethylene propylene rubber, and acrylonitrile-butadiene rubber. The rubber-based polymer is preferably also cross-linked, thus making it easy to control the peeling strength within the above described range.

The releasable adhesive layer is preferably transparent as far as possible. The light transmission coefficient is usually more than 80%, preferably more than 85%, particularly preferably more than 90%. “The light transmission coefficient” in this specification is the total light transmission coefficient, which is measured with a spectrophotometer or colormeter functioning as photometer with the light of 550 nm. In addition, the thickness of the releasable adhesive layer is usually 10 to 200 μm, preferably 20 to 100 μm.

Film Layer

The film layer incorporated into the optical filter of this invention comprises the optical film. The optical film is a film which can provide the adhered layer with the optical functions. Here “the optical functions” are functions which control one or more properties selected from the group consisting of: light transmission coefficient, reflectivity, refractive index and transmission direction.

For example, the optical filter is a louver layer alone or a louver film comprising a louver layer. The louver layer is a film having small louvers (louver-like elements) incorporated within the layer, controlling the transmission direction. The louver layer usually comprises light transmission part and small louver-like elements, which block light.

The light transmission part has preferably a width larger than that of louver-like elements (the dimension in a direction parallel with the surface of the louver layer and orthogonal to the length of the louver-like elements) so as not to reduce light transmission coefficient of the entire optical filter. The width of the light transmission part is preferably 50 to 500 μm, particularly preferably 70 to 200 μm.

The louver-like element has preferably a width less than that of light transmission part so as not to reduce light transmission coefficient of the entire optical filter. The width of louver-like element is 1 to 100 μm, preferably 10 to 50 μm. The angle of louver-like element is usually within the range from 45 to 90 degrees. The angle of the louver-like element is measured to the surface of the louver layer, and is defined to be 90 degrees when orthogonal to the surface.

The thickness of the louver layer can be determined appropriately depending on the application. As the thickness decreases, however, the effect of controlling the direction of light tends to be lowered. On the other hand, the thickness as increases the flexibility of the tabs may be lowered if they are formed of a part of the film layer. Therefore, its thickness is preferably 10 to 700 μm, and particularly preferably 40 to 500 μm.

The transmission part of the louver layer is preferably formed of a polymer which has a high transparency and relatively high flexibility. Thermoplastic resin, thermosetting resin, resin curable by energy rays such as ultraviolet and the like are used as the polymer. The examples include: cellulose resin such as cellulose acetate butylate and triacetyl cellulose; polyolefin resin such as polyethylene and polypropylene; polyester resin such as polyethylene terephthalate; polystyrene; polyurethane; polyvinyl chloride; acrylic resin; and polycarbonate resin.

The louver-like element is formed of a light shielding material, which can absorb or reflect light. The examples include: (1) dark colored pigments and dyes such as black and gray, (2) metals such as aluminum and silver, (3) dark colored metal oxides, and (4) the above cited polymers incorporating dark colored pigments or dyes.

As disclosed in the patents already mentioned in the part of the Prior Art, the above described louver layer can be produced, for example, as follows. First the louver-like element is formed by fixing the layer containing a light shielding material on one main surface of the polymer film used for the light transmission part, thus making a laminate film set of a polymer film and a light shielding material layer. A number of the sets are prepared, and then laminated together to form a precursor of a louver film where the polymer film and the light shielding material layer are alternated, and fixed together. The precursor is sliced to a predetermined thickness in a direction orthogonal to the main surface (lamination surface) of precursor (the laminating direction) to form the louver layer.

A commercially available louver film can be also used as a louver film comprising a louver layer. Further, a commercially available louver layer for louver film can be used as a louver layer which is used as a component of the optical filter of this invention. The above described “Light Control Film” made by 3M Company is cited as an example of such a commercially available louver film. The commercially available louver film is sufficiently flexible because of molded polymer. The tab formed of a part of that louver film has a certain level of flexibility, which makes it easy to release the optical filter.

Antireflection film, Fresnel lens film, electromagnetic shielding film and the like can be used as an optical film, besides louver films. In addition, the film layer may have two or more optical films, and may have a light transmission film other than optical films. The thickness of the entire film layer is usually 20 to 800 μm.

### EXAMPLES

In this example, an optical film was formed with one round tab having a substantially semicircular tip in the extension direction, as shown in FIG. 3.

The precursor of optical film used in this example was the privacy filter (made by 3M Corporation, the product number: LC38DS) comprising a 260 μm thick louver film with a field of view of 90 degrees and a releasable adhesive layer. In the louver film, the width of the light transmission part was 100 μm, and that of the louver-like element was 10 μm. The thickness of the optical filter's precursor was 380 μm. The observed surface of the optical filter's precursor was a rectangular with 56 mm in length (Y) and 150 mm in width (X).

Furthermore the peeling strength of releasable adhesive layer was measured as follows. First the same releasable adhesive layer as above described was placed on the surface of a 38 μm thick PET film substrate, preparing an adhesive film with a releasable adhesive layer. The thickness of the releasable adhesive layer was 55 μm. The light transmission coefficient of the adhesive film (including the releasable adhesive layer) was 90%.

Then the adhesive film was cut into samples of 15 cm×25 mm. After cleaning the adhesion surface with IPA, the sample was pressed onto a PET film (100 μm thick) with a roller (2 kg weight) conforming to JISZ0237 at 20° C.×65%RH, and leaving it under the same conditions for 3 hours. Then the peeling strength was measured with a tensile tester under the following conditions. The measurement was performed by a peeling tester made by Imass Corporation in US (the product name: I-mass Tester, MODEL SP-102C) on the condition that the peeling angle was 90 degrees and the peeling rate was 90 inch/min (about 229 cm/min). As the result, the peeling strength to PET was found to be 0.65N/25 mm in the optical filter of this example.

Using the optical filter's precursor thus made, the optical filter of this example was completed, by cutting one corner of the rectangular observed surface and forming a tab of the part left. That is to say, the tab was formed of a part of the laminate comprising the optical filter and the releasable adhesive layer. In addition, the laminate itself was flexible and the tab was also flexible.

In the optical filter of this example, two-dimensional size of the tab and its neighbor was as follows: the protruding length (L) of the tab=10 mm, the width of the tab (W)=5 mm, the length of an oblique side formed by the cutting (S)=25 mm, the length from a corner of the oblique side to a fixed end of the tab (D)=10 mm.

Then the optical filter of this example was closely attached to the screen of a touch panel type liquid crystal display by the releasable adhesive layer, and practical tests were carried out. As the result of the tests, it was found that the surface of the touch panel and the optical filter could be closely attached to each other without any gap, and there was no malfunction when inputting analog characters and pushing buttons on the touch panel. Furthermore it was easy to remove the optical filter once fixed and fix it again. After re-fixing, the surface of the touch panel and the optical filter could be closed attached to each other and there was no malfunction in the operation of touch panel.

Moreover the optical filter was easily fixed to the display screen to give sufficient anti-peering effect in that displayed information on the screen could not be read when peeped in a direction away from the front (about 45 degrees). The fixed optical filter was easily removed and again fixed. The tab was easily lifted and picked. Further picking and applying force to the tab, the optical filter could be easily removed.

We claim:

1. An optical filter, comprising:
(a) a film layer formed of an optical film having a front surface observed by an observer and a back surface opposing to the front surface,
(b) a releasable adhesive layer which is firmly placed on the back surface of the film layer and can be releasably adhered to the adhesion surface,
Wherein a flexible tab is provided coupled integrally with said film layer in the optical filter fixed to said adhesion surface by the releasable adhesive layer.

2. The optical filter of claim 1 wherein said tab comprises a tab part formed of a part of said film layer.

3. The optical filter of claim 1 wherein the optical filter is formed by processing a precursor of the optical filter having a substantially rectangular surface to be observed, and that said tab is formed of a part of said precursor of the optical filter, which is left after cutting off a part including at least one of four corners of said precursor of the optical filter.

4. The optical filter of claim 1 wherein said releasable adhesive layer is formed of a releasable adhesive containing a cross-linked tacky polymer or rubber-based polymer.

5. The optical filter of claim 1 wherein said optical film is a louver film.
